(19) United States
(12) Patent Application Publication
(10) Pub. No.: US 2015/0227827 A1
(43) Pub. Date: Aug. 13, 2015

(54) PORTABLE INFORMATION TERMINAL AND BARCODE DISPLAY METHOD

(71) Applicant: TOSHIBA TEC KABUSHIKI KAISHA, Tokyo (JP)

(72) Inventor: Kenji Sakurai, Izunokuni (JP)

(21) Appl. No.: 14/614,536

(22) Filed: Feb. 5, 2015

(30) Foreign Application Priority Data
Feb. 10, 2014 (JP) 2014-023196

(51) Int. Cl. G06K 19/06

(52) U.S. Cl. CPC G06K 19/06112; G06K 19/06028

(57) ABSTRACT

In accordance with one embodiment, a portable information terminal comprises a display section having a resolution configured to display information; a storage section configured to store barcode data; and a control section configured to acquire the resolution of the display section, calculate the number of pixels in the longitudinal direction and the number of pixels in the lateral direction of a barcode to be displayed based on the acquired resolution, generate a barcode to be displayed based on the calculated number of pixels in the longitudinal direction and the number of pixels in the lateral direction, and then display the generated barcode on the display section.

### CROSS-REFERENCE TO RELATED APPLICATION

This application is based upon and claims the benefit of priority from Japanese Patent Application No. 2014-023196, filed Feb. 10, 2014, the entire contents of which are incorporated herein by reference.

### FIELD

Embodiments described herein relate generally to a portable information terminal and a barcode display method.

### BACKGROUND

In recent years, the popularization of portable information terminal such as smart phone, tablet terminal and the like is remarkable. In this background, a technology of using the portable information terminal instead of a member card of a commodity store or service store is becoming more and more popular.

Specifically, the barcode displayed on a conventional member card is displayed on a touch panel of the portable information terminal and read by a conventional scanner to carry out a member authentication by a POS (Point of sales) terminal.

However, the portable information terminals are of various sizes, thus, there is a case in which the barcode displayed on the touch panel through the conventional technology is too large or too small, or a case in which the barcode is blurred.

In these cases, the barcode cannot be read successfully. As a result, the member cannot be authenticated.

### BRIEF DESCRIPTION OF THE DRAWINGS

FIG. 1 is a front view illustrating a portable information terminal;

FIG. 2 is a block diagram illustrating the constitution of the portable information terminal;

FIG. 3 is a flowchart illustrating the operations of the portable information terminal;

FIG. 4 is a flowchart illustrating the operations of a portable information terminal according to a modification; and

FIG. 5 is a front view illustrating the portable information terminal in which a barcode is displayed.

### DETAILED DESCRIPTION

In accordance with one embodiment, a portable information terminal comprises a display section configured to display information; a storage section configured to store barcode data; and a control section configured to acquire the resolution of the display section, calculate the number of pixels in the longitudinal direction and the number of pixels in the lateral direction of a barcode to be displayed based on the acquired resolution, generate a barcode to be displayed based on the calculated number of pixels in the longitudinal direction and the number of pixels in the lateral direction, and then display the generated barcode on the display section.

Hereinafter, one embodiment of the portable information terminal and the barcode display method is described in detail with reference to the accompanying drawings.

The portable information terminal according to the present embodiment is provided with a display section for displaying information; a storage section for storing barcode data; and a control section which acquires the resolution of the display section, calculates the number of pixels in the longitudinal direction and the number of pixels in the lateral direction of a barcode to be displayed based on the acquired resolution, generates a barcode to be displayed based on the calculated number of pixels in the longitudinal direction and the number of pixels in the lateral direction, and then displays the generated barcode on the display section.

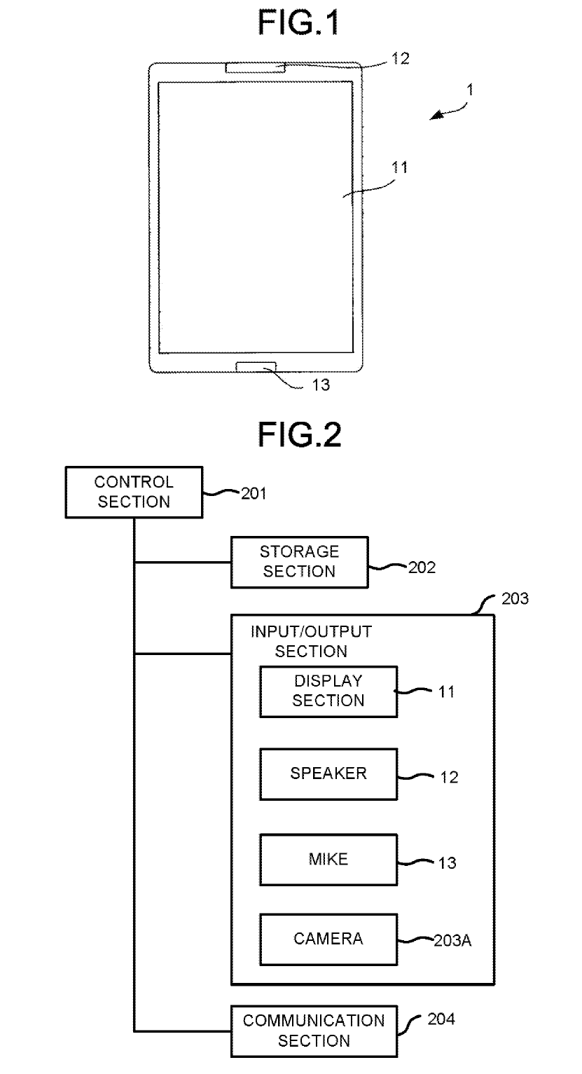

FIG. 1 is a front view illustrating a portable information terminal 1. As shown in FIG. 1, the portable information terminal 1 is equipped with a display section 11 for displaying information such as a touch panel, a display and the like, a speaker 12 for outputting a speech and a mike 13.

The display section 11 may also be used as an input device.

FIG. 2 is a block diagram illustrating the constitution of the portable information terminal 1. As shown in FIG. 2, the portable information terminal 1 is equipped with a control section 201 including a CPU (Central processing unit) serving as an arithmetic device; a storage section 202 including a memory such as a ROM, a RAM and the like and a storage device such as a hard disk drive; an input/output section 203 for inputting/outputting information; and a communication section 204 for carrying out communication.

The storage section 202 stores barcode display programs. The control section 201 reads the barcode display programs from the storage section 202 and executes the barcode display programs in sequence.

The input/output section 203 includes the display section 11, the speaker 12, the mike 13, and a camera 203A arranged at the back side. The camera 203A may be arranged at the front side.

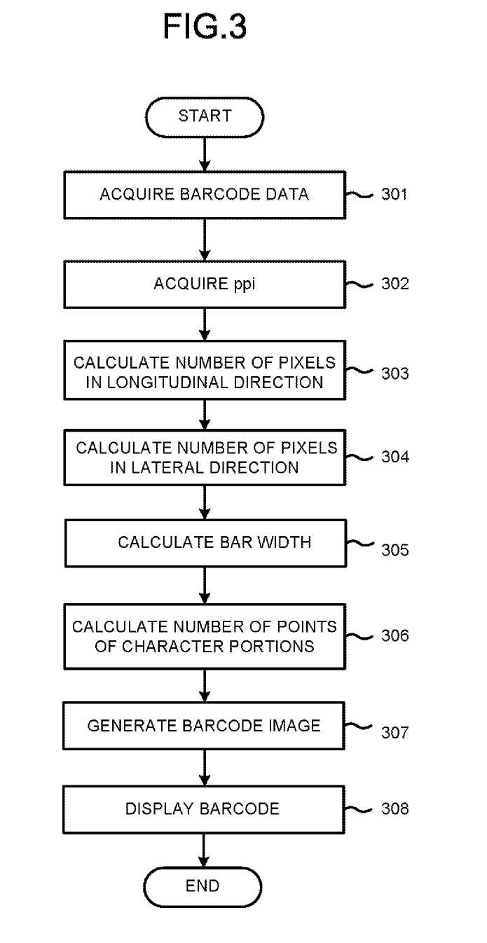

FIG. 3 is a flowchart illustrating the operations of the portable information terminal 1. As shown in FIG. 3, the portable information terminal 1 acquires barcode data serving as numerical data of the barcode to be generated from the storage section 202 in ACT 301.

In ACT 302, the portable information terminal 1 acquires the resolution (ppi: pixel per inch) of the display section 11. The portable information terminal 1 can inquire of an OS (operation system) through a command to acquire the resolution of the display section 11.

In ACT 303, the portable information terminal 1 calculates the number of pixels in the longitudinal direction of the barcode to be displayed. Specifically, the size in the longitudinal direction of the barcode in JIS (Japanese Industrial Standards) standard is 26.6 mm, thus, the following formula (1) is established.

26.6=(Ph/D)×25.4 Formula (1):

Herein, Ph refers to the number of pixels in the longitudinal direction, D refers to the resolution (ppi), and 25.4 refers to the length (mm) of one inch.

The following formula (2) is obtained after solving the formula (1) for Ph.

Ph=1.047×D Formula (2):

For example, in a smart phone of which the longitudinal length of the display section 11 is 112.2 mm and the resolution is 480 ppi (D=480), the number of pixels in the longitudinal direction is 1.047×480=502 pixels.

In a tablet terminal of which the longitudinal length of the display section 11 is 135.6 mm and the resolution is 320 ppi (D=320), the number of pixels in the longitudinal direction is 1.047×320=335 pixels.

Thus, it is closer to the longitudinal length of the JIS standard compared with a case of magnification/reduction based on the longitudinal length of the display section 11.

In ACT 304, the portable information terminal 1 calculates the number of pixels in the lateral direction of the barcode to be displayed. Specifically, the size in the lateral direction of the barcode in JIS standard is 37.3 mm, thus, the following formula (3) is established.

37.3=(Pw/D)×25.4 Formula (3)

Herein, Pw refers to the number of pixels in the lateral direction, D refers to the resolution (ppi), and 25.4 refers to the length (mm) of one inch.

The following formula (4) is obtained after solving the formula (3) for Pw.

Pw=1.469×D Formula (4)

For example, in a smart phone of which the lateral length of the display section 11 is 60.4 mm and the resolution is 480 ppi (D=480), the number of pixels in the lateral direction is 1.469×480=705 pixels.

In a tablet terminal of which the lateral length of the display section 11 is 216.96 mm and the resolution is 320 ppi (D=320), the number of pixels in the lateral direction is 1.469×320=470 pixels.

Thus, it is closer to the lateral length of the JIS standard compared with a case of magnification/reduction based on the lateral length of the display section 11.

In ACT 305, the portable information terminal 1 calculates the bar width of the barcode according to the width of the barcode of the JIS standard and the resolution of the display section 11 as stated in ACT 303.

In ACT 306, the portable information terminal 1 calculates the number of points of character portions according to the number of points of character portions of the JIS standard and the resolution of the display section 11 as stated in ACT 303.

In ACT 307, the portable information terminal 1 generates a barcode image based on the barcode data, the calculated number of pixels in the longitudinal direction, the number of pixels in the lateral direction, the bar width and the number of points of the character portions.

In ACT 308, the portable information terminal 1 displays the generated barcode on the display section 11.

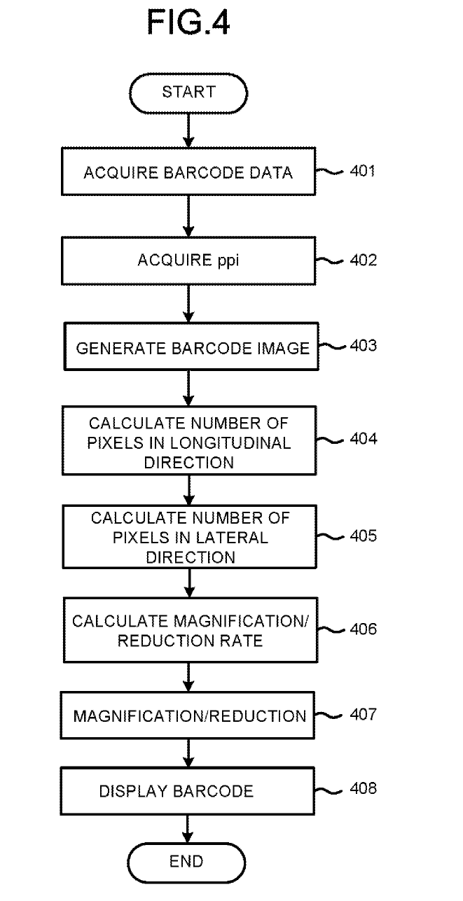

FIG. 4 is a flowchart illustrating the operations of the portable information terminal 1 according to a modification. As shown in FIG. 4, in ACT 401, the portable information terminal 1 acquires barcode data serving as numerical data of the barcode to be generated from the storage section 202.

In ACT 402, the portable information terminal 1 acquires the resolution (ppi) of the display section 11. The portable information terminal 1 can inquire of the OS through a command to acquire the resolution of the display section 11.

In ACT 403, the portable information terminal 1 generates a barcode image based on the barcode data according to default settings.

In ACT 404, the portable information terminal 1 calculates the number of pixels in the longitudinal direction of the barcode to be displayed. Specifically, the number of pixels in the longitudinal direction is calculated according to the formula (2) mentioned above.

For example, in a smart phone of which the longitudinal length of the display section 11 is 112.2 mm and the resolution is 480 ppi (D=480), the number of pixels in the longitudinal direction is 1.047×480=502 pixels.

In a tablet terminal of which the longitudinal length of the display section 11 is 135.6 mm and the resolution is 320 ppi (D=320), the number of pixels in the longitudinal direction is 1.047×320=335 pixels.

Thus, it is closer to the longitudinal length of the JIS standard compared with a case of magnification/reduction based on the longitudinal length of the display section 11.

In ACT 405, the portable information terminal 1 calculates the number of pixels in the lateral direction of the barcode to be displayed. Specifically, the number of pixels in the lateral direction is calculated according to the formula (4) mentioned above.

For example, in a smart phone of which the lateral length of the display section 11 is 60.4 mm and the resolution is 480 ppi (D=480), the number of pixels in the lateral direction is 1.469×480=705 pixels.

In a tablet terminal of which the lateral length of the display section 11 is 216.96 mm and the resolution is 320 ppi (D=320), the number of pixels in the lateral direction is 1.469×320=470 pixels.

Thus, it is closer to the lateral length of the JIS standard compared with a case of magnification/reduction based on the lateral length of the display section 11.

In ACT 406, the portable information terminal 1 calculates a magnification/reduction rate according to the default number of pixels in the longitudinal direction and the calculated number of pixels in the longitudinal direction of the barcode to be displayed.

For example, in a case in which the default number of pixels in the longitudinal direction of the barcode image is 4700 pixels, 470/4700=0.1, thus, the reduction rate is 0.1 times.

Alternatively, the portable information terminal 1 calculates the magnification/reduction rate according to the default number of pixels in the lateral direction and the calculated number of pixels in the lateral direction of the barcode to be displayed.

In ACT 407, the portable information terminal 1 magnifies or reduces the barcode generated under default conditions according to the magnification/reduction rate calculated above.

In ACT 408, the portable information terminal 1 displays the magnified or reduced barcode on the display section 11.

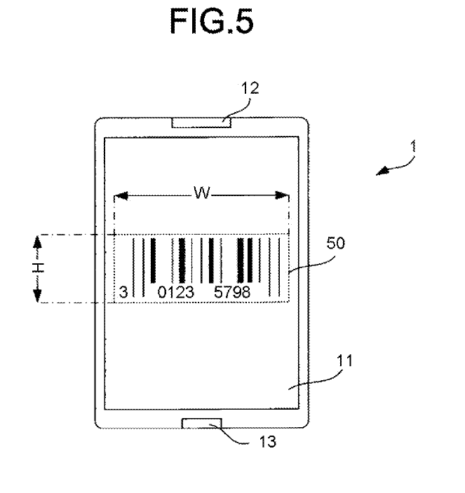

FIG. 5 is a front view illustrating the portable information terminal 1 in which the barcode is displayed. As shown in FIG. 5, in accordance with the portable information terminal 1 of the present embodiment, a barcode 50 is displayed in a size close to the size of the JIS standard in such a manner that the length W in the lateral direction and the length H in the longitudinal direction are regardless of the size of the display section 11 and the direction.

As stated above, the portable information terminal 1 according to the present embodiment is equipped with the display section 11 for displaying information; the storage section 202 for storing the barcode data; and the control section which acquires the resolution of the display section 11, calculates the number of pixels in the longitudinal direction and the number of pixels in the lateral direction of the barcode to be displayed based on the acquired resolution, and then generates the barcode to be displayed based on the calculated number of pixels in the longitudinal direction and the number of pixels in the lateral direction.

In this way, it is possible to display a barcode that can be read successfully regardless of the size of the input/output section of the portable information terminal.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A portable information terminal comprising:
a display section having a resolution configured to display information;
a storage section configured to store barcode data; and
a control section configured to acquire the resolution of the display section, calculate the number of pixels in the longitudinal direction and the number of pixels in the lateral direction of a barcode to be displayed based on the acquired resolution, generate a barcode to be displayed based on the calculated number of pixels in the longitudinal direction and the number of pixels in the lateral direction, and then display the generated barcode on the display section.

2. The portable information terminal according to claim 1, wherein
the control section further calculates the number of pixels of a bar width constituting the barcode to be displayed based on the resolution, and
generates the barcode to be displayed based on the calculated number of pixels of the bar width, the number of pixels in the longitudinal direction and the number of pixels in the lateral direction, and then displays the generated barcode on the display section.

3. The portable information terminal according to claim 1, wherein
the control section creates a barcode image under a default condition,
acquires the resolution of the display section,
calculates the number of pixels in the longitudinal direction and the number of pixels in the lateral direction of the barcode to be displayed based on the acquired resolution,
calculates a magnification/reduction rate according to the longitudinal length or the lateral length of the barcode image and the longitudinal length or the lateral length of the barcode to be displayed, and
magnifies or reduces the barcode image based on the magnification/reduction rate and then displays the barcode image on the display section.

4. A barcode display method for a portable information terminal provided with a display section having a resolution configured to display information, a storage section configured to store barcode data, and a control section configured to include an arithmetic device, including:
acquiring the resolution of the display section;
calculating the number of pixels in the longitudinal direction and the number of pixels in the lateral direction of a barcode to be displayed based on the acquired resolution;
generating a barcode to be displayed based on the calculated number of pixels in the longitudinal direction and the number of pixels in the lateral direction; and
displaying the generated barcode on the display section.

5. The barcode display method according to claim 4, further including:
calculating the number of pixels of a bar width constituting the barcode to be displayed based on the resolution, and
generating the barcode to be displayed based on the calculated number of pixels of the bar width, the number of pixels in the longitudinal direction and the number of pixels in the lateral direction.

6. The barcode display method according to claim 4, further including:
creating a barcode image under a default condition,
calculating a magnification/reduction rate according to the longitudinal length or the lateral length of the barcode image and the longitudinal length or the lateral length of the barcode to be displayed, and
magnifying or reducing the barcode image based on the magnification/reduction rate and then displaying the barcode image on the display section.
